(19) United States
(12) Patent Application Publication
(10) Pub. No.: US 2008/0005494 A1
(43) Pub. Date: Jan. 3, 2008

(54) Supporting flash access in a partitioned platform

(76) Inventors: Vincent J. Zimmer, Federal Way, WA (US); Steven B. McGowan, Portland, OR (US); Michael A. Rothman, Puyallup, WA (US)

Correspondence Address: INTEL CORPORATION;c/o INTELLEVATE, LLC, P.O. BOX 52050, MINNEAPOLIS, MN, 55402, US

(21) Appl. No.: 11/449,254

(22) Filed: Jun. 7, 2006

(51) Int. Cl. G06F 12/14

(52) U.S. Cl. 711/152

(57) ABSTRACT

In an embodiment, a method is provided. The method of this embodiment provides providing a first interface between a first system partition and an embedded agent, the embedded agent having privileged access to a system resource; providing a second interface between a second system partition and the embedded agent; and granting the second system partition access to the system resource via the second interface.

### FIELD

Embodiments of this invention relate to supporting flash access in a partitioned platform.

### BACKGROUND

Virtualization refers to an ability of a platform to be partitioned in order to function and be perceived as multiple platforms using the hardware and/or software resources of the single platform. Virtualization may be used, for example, in embedded IT (information technology), or the integration of security and management capabilities into a platform. By using virtualization in an EIT environment, work may be partitioned into multiple environments, so that one environment does not affect another. As an example, a first partition may allow a user to perform daily tasks such as email, web browsing, and word processing, and a second partition may be created that is tamper resistant to allow manageability and security to be under the control of an IT department.

Certain features that may be available in an unpartitioned platform may not be easily available to every partition in a partitioned platform. As an example, an embedded agent may have access to system resource that is exclusive of other components and processes in an unpartitioned platform, but which may be made available to other components and processes via an interface between the components and processes and the embedded agent. When the platform is partitioned, however, allowing each partition in the partitioned platform to access a particular system resource may require replication of the system resource. This may not merely introduce complexities to the platform, but may also result in undesired costs.

### BRIEF DESCRIPTION OF THE DRAWINGS

Embodiments of the present invention are illustrated by way of example, and not by way of limitation, in the figures of the accompanying drawings and in which like reference numerals refer to similar elements and in which:

FIG. 1 illustrates an unpartitioned platform.

FIG. 2 illustrates the unpartitioned platform of FIG. 1 in further detail.

FIG. 3 illustrates a partitioned platform according to an embodiment.

FIG. 4 illustrates the partitioned platform of FIG. 3 in further detail according to an embodiment.

FIG. 5 is a flowchart illustrating a method according to an embodiment.

### DETAILED DESCRIPTION

Examples described below are for illustrative purposes only, and are in no way intended to limit embodiments of the invention. Thus, where examples may be described in detail, or where a list of examples may be provided, it should be understood that the examples are not to be construed as exhaustive, and do not limit embodiments of the invention to the examples described and/or illustrated.

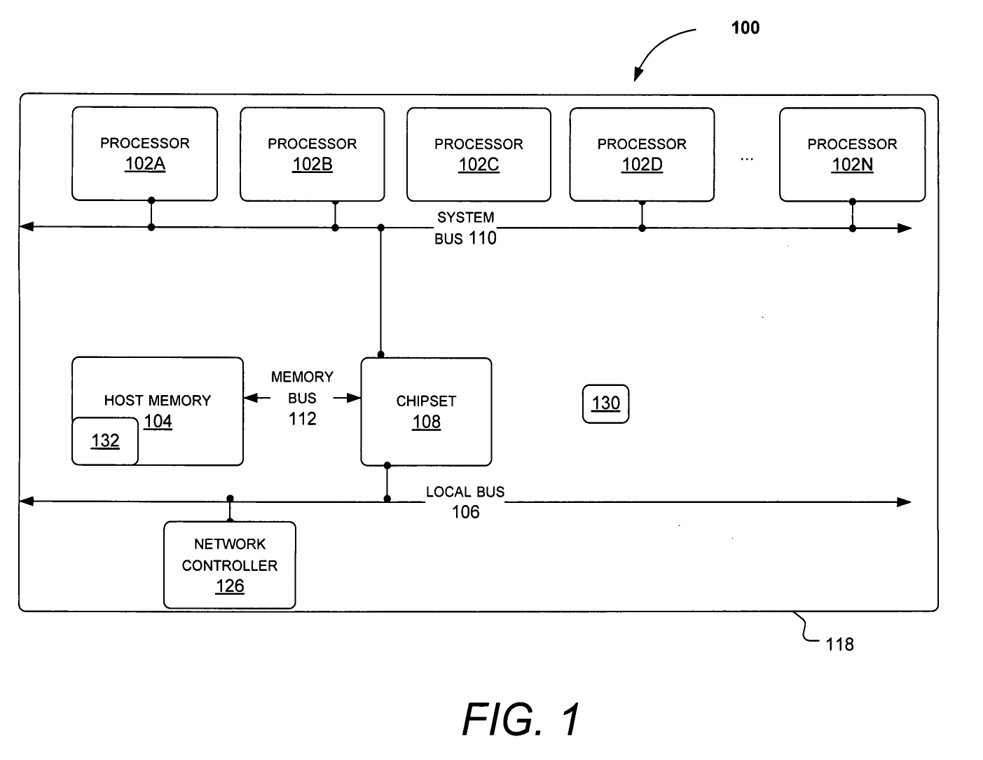

Methods described herein may be implemented in a system, such as platform 100 illustrated in FIG. 1. Platform 100 may comprise one or more processors 102A, 102B, 102C, 102D, . . . , 102N. A “processor” as discussed herein relates to a combination of hardware and software resources for accomplishing computational tasks. For example, a processor may comprise a system memory and processing circuitry (e.g., a central processing unit (CPU) or microcontroller) to execute machine-readable instructions for processing data according to a predefined instruction set. Alternatively, a processor may comprise just the processing circuitry (e.g., CPU). A processor may comprise a multi-core processor having a plurality of computational engines. Alternatively, a processor may comprise a computational engine that may be comprised in the multi-core processor, where an operating system may perceive the computational engine as a discrete processor with a full set of execution resources. Other possibilities exist.

Platform 100 may additionally comprise memory 104. Memory 104 may store machine-executable instructions 132 that are capable of being executed, and/or data capable of being accessed, operated upon, and/or manipulated. “Machine-executable” instructions as referred to herein relate to expressions which may be understood by one or more machines for performing one or more logical operations. For example, machine-executable instructions 132 may comprise instructions which are interpretable by a processor compiler for executing one or more operations on one or more data objects. However, this is merely an example of machine-executable instructions and embodiments of the present invention are not limited in this respect. Memory 104 may, for example, comprise read only, mass storage, random access computer-accessible memory, and/or one or more other types of machine-accessible memories.

Chipset 108 may comprise one or more integrated circuit chips, such as those selected from integrated circuit chipsets commercially available from Intel® Corporation (e.g., graphics, memory, and I/O controller hub chipsets), although other one or more integrated circuit chips may also, or alternatively, be used. Chipset 108 may comprise a host bridge/hub system that may couple processor 102A, 102B, 102C, 102D, . . . , 102N, and host memory 104 to each other and to local bus 106. Chipset 108 may communicate with memory 104 via memory bus 112 and with processor 102A, 102B, 102C, 102D, . . . , 102N via system bus 110. According to an embodiment, platform 100 may comprise one or more chipsets 108 including, for example, an input/output control hub (ICH), and a memory control hub (MCH), although embodiments of the invention are not limited to this.

Local bus 106 may comprise a bus that complies with the Peripheral Component Interconnect (PCI) Local Bus Specification, Revision 3.0, Feb. 3, 2004 available from the PCI Special Interest Group, Portland, Oreg., U.S.A. (hereinafter referred to as a “PCI bus”). Alternatively, for example, bus 106 may comprise a bus that complies with the PCI Express™ Base Specification, Revision 1.1, Mar. 28, 2005 also available from the PCI Special Interest Group (hereinafter referred to as a “PCI Express bus”). Bus 106 may comprise other types and configurations of bus systems.

Platform 100 may additionally comprise one or more network controllers 126 (only one shown). A “network controller” as referred to herein relates to a device which may be coupled to a communication medium to transmit data to and/or receive data from other devices coupled to the communication medium, i.e., to send and receive network traffic. For example, a network controller may transmit packets to and/or receive packets from devices coupled to a network such as a local area network. As used herein, a “packet” means a sequence of one or more symbols and/or values that may be encoded by one or more signals transmitted from at least one sender to at least one receiver. Such a network controller 126 may communicate with other devices according to any one of several data communication formats such as, for example, communication formats according to versions of IEEE (Institute of Electrical and Electronics Engineers) Std. 802.3 (CSMA/CD Access Method, 2002 Edition); IEEE Std. 802.11 (LAN/MAN Wireless LANS, 1999 Edition), IEEE Std. 802.16 (2003 and 2004 Editions, LAN/MAN Broadband Wireless LANS), Universal Serial Bus, Firewire, asynchronous transfer mode (ATM), synchronous optical network (SONET) or synchronous digital hierarchy (SDH) standards.

In an embodiment, network controller 126 may be comprised on system motherboard 118. Rather than reside on motherboard 118, network controller 126 may be integrated onto chipset 108. Still alternatively, network controller 126 may be comprised in a circuit card (not shown, e.g., NIC or network interface card) that may be inserted into circuit card slot (not shown).

Platform 100 may comprise logic 130. Logic 130 may comprise hardware, software, or a combination of hardware and software (e.g., firmware). For example, logic 130 may comprise circuitry (i.e., one or more circuits), to perform operations described herein. For example, logic 130 may comprise one or more digital circuits, one or more analog circuits, one or more state machines, programmable logic, and/or one or more ASICs (Application-Specific Integrated Circuits). Logic 130 may be hardwired to perform the one or more operations. Alternatively or additionally, logic 130 may be embodied in machine-executable instructions 132 stored in a memory, such as memory 104, to perform these operations. Alternatively or additionally, logic 130 may be embodied in firmware. Logic may be comprised in various components of platform 100, including network controller 126, chipset 108, processor 102A, 102B, 102C, 102D, . . . , 102N, and/or on motherboard 118. Logic 130 may be used to perform various functions by various components as described herein.

Platform 100 may comprise more than one, and other types of memories, buses, processors, and network controllers. Processors 102A, 102B, 102C, 102D, . . . , 102N, memory 104, and busses 106, 110, 112 may be comprised in a single circuit board, such as, for example, a system motherboard 118, but embodiments of the invention are not limited in this respect.

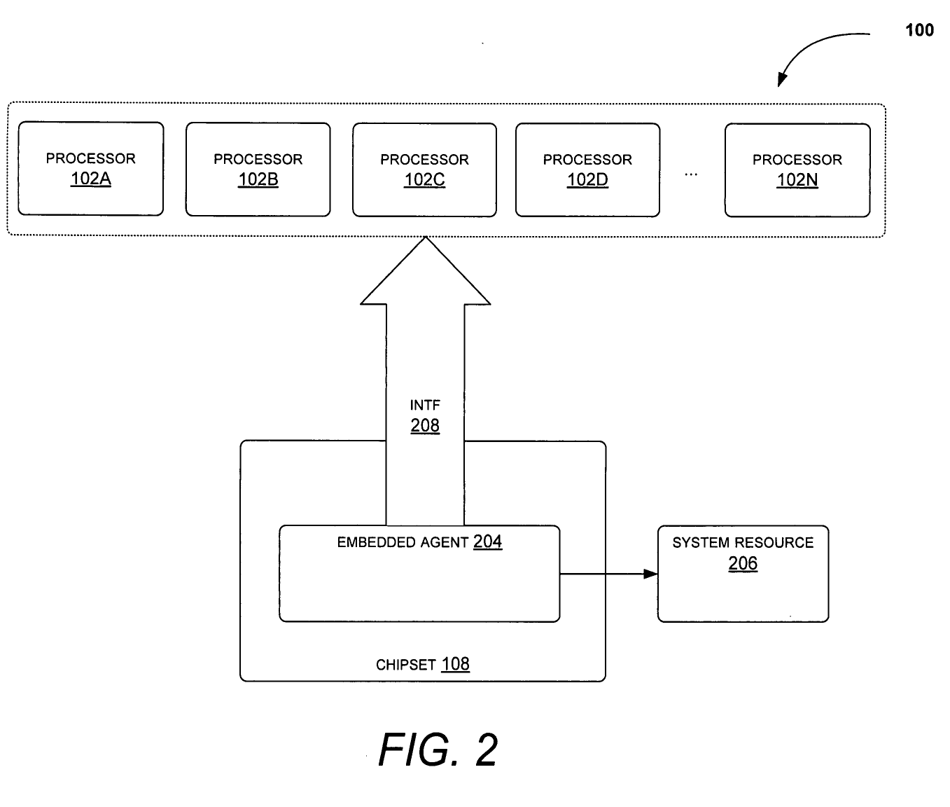

As illustrated in FIG. 2, chipset 108 may comprise embedded agent 204. Embedded agent may comprise, for example, a microcontroller or a microprocessor. In an embodiment, embedded agent 204 may enable manageability functions to be performed on a system, such as platform 100. Manageability functions may comprise, for example, software updates/upgrades, running system diagnostics, and asset management. In an embodiment, embedded agent 204 may enable out-of-band manageability of platform 100. Out-of-band manageability refers to the ability to manage a platform regardless of the state of the operating system (e.g., running, in a reduced power state, or disabled due to system crash) or system power. In an embodiment, embedded agent 204 may enable platform 100 to conform with Intel® Active Management Technology (IAMT), available from Intel® Corporation.

As further illustrated in FIG. 2, platform 100 may comprise system resource 206. In an embodiment, system resource 206 may comprise a non-volatile storage (NVS) 206 which is capable of storing information in addressable locations when power is removed from platform 300. The NVS 206 may comprise any one of several types of non-volatile memory devices such as, for example, flash memory devices, polymer memory devices, magnetic memory devices or optical memory devices. NVS 206 may maintain firmware for a platform basic input/output system (BIOS) or private data storage. Out-of-band manageability may entail accessing NVS 206 to determine hardware or software configuration information independently of whether the operating system is running. For example: a network security application may access NVS 206 to discover and patch security vulnerabilities; and operating system recovery tools may access the NVS 206 to access hardware or software configuration information to restore applications in the event of an operating system crash. In an alternative embodiment, embedded agent 204 and/or NVS 206 may instead be located, for example, on network controller 126.

According to an embodiment, embedded agent 204 may control allocation of portions of NVS 206 to application programs or other processes according to allocation control data (ACD). Embedded agent 204 may control all allocation and read and write access to at least a predetermined physical portion of the NVS 206 (either contiguous or non-contiguous) which is available for allocation for use by instances of application programs or other processes. In an embodiment, the ACD may comprise one or more data structures residing in a dedicated portion of NVS 206 that is accessible through embedded agent 204 to the exclusion of other processes. Particular instances of an application program or other process may request an allocation of a portion of the dedicated portion of NVS 206. For each instance of an application program, the ACD may maintain a record associated with the instance including an identifier, size of total allocation available to the instance and size of current allocation to the instance. As more than one instance of an application program may exist at any particular time, a record in the ACD may be associated with a particular instance of an application program to receive an allocation of NVS 206. A corresponding handle or identifier may uniquely distinguish a record in the ACD for a particular instance of an application program from different instances of the same application program and instances of other application programs. Additional portions of NVS 206 may be allocated to a requesting application program or process up to a maximum size according to the record in the ACD associated with the requesting application program or process. In one alternative embodiment, ACD may indicate a maximum allocation size for all application programs or processes having a cumulative potential total memory allocation that exceeds the storage available on the dedicated portion of NVS 206. It should be noted, however, that not all applications or processes may request an allocation of NVS 206 as specified in the records of the ACD.

Embedded agent 204 may manage NVS 206 for various needs. As an example, embedded agent 204 may reserve entries in the ACD corresponding with application programs developed by partner vendors who have agreed (e.g., by contractual arrangement) with the manufacturer that assembles the components of platform 100 for some amount of NVS 206 storage to be set aside. These partner entries may be distinguished from other “non-partner” records in the ACD that correspond with application programs or process that are not provided by a software vendor having such an arrangement with the manufacturer. In one embodiment, the manufacturer may pre-load entries in the ACD associated with partner processes or application programs when platform 100 is manufactured. Entries in the ACD associated with non-partner processes or application programs may be added to the ACD after platform 100 is deployed. Entries associated with non-partner processes or application programs may be subsequently created by, for example, application programs executing on platform 100 or a remote process communicating with platform 100.

According to an embodiment, a process or instances of an application program may request an allocation of a portion of NVS 206 to store information such as, for example, hardware configuration information (e.g., information descriptive of the existence or status of a processor, chipset, system memory, hard drive, network controller(s) or other peripheral devices) and software configuration information (e.g., information descriptive of the existence or status of an operating system, application programs being hosted on the host including versions of application programs and security patch levels associated with the application programs). Additional details and uses of NVS 206 by embedded agent 204 are disclosed in U.S. patent application Ser. No. 10/937,755, titled “Operating System Independent Agent”, filed Sep. 8, 2004.

In an embodiment, embedded agent 204 may have privileged access to NVS 206. As used herein, “privileged access” refers to access that is exclusive of other components and/or processes. Privileged access may be a result of a specific hardware configuration. For example, platform 300 may comprise a dedicated bus between embedded agent 204 and system resource 206. To bridge the gap between components and processes on platform 300 and system resource 206, an interface may be used. For example, INTF 208 may provide hardware and software resources to enable communications between embedded agent 204 and one or more processors 102A, 102B, 102C, 102D, . . . , 102N, and may further enable one or more processors 102A, 102B, 102C, 102D, . . . , 102N to access NVS 206. These resources may include, for example, configuration spaces, buffers, registers, and dedicated memories.

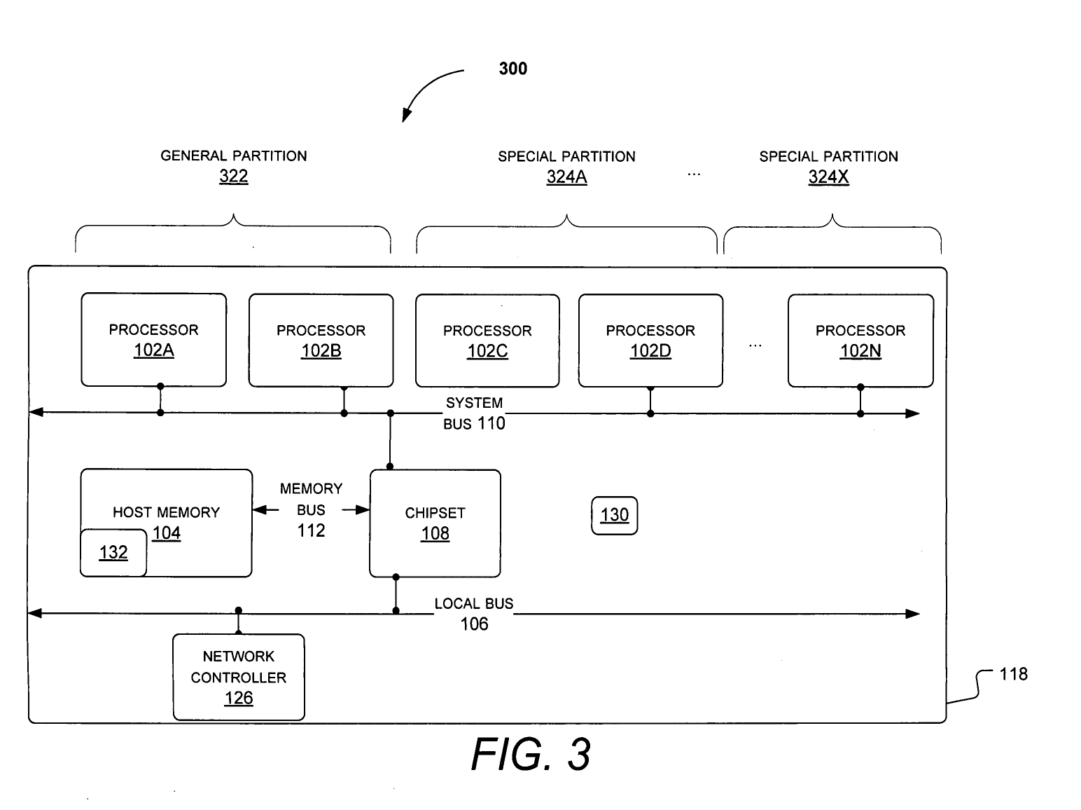

FIG. 3 illustrates a platform 300 according to at least one embodiment of the invention. As illustrated in FIG. 3, platform 300 may comprise a plurality of partitions. In an embodiment, each partition may comprise a set of processors from processors 102A, 102B, 102C, 102D, . . . , 102N. For example, as illustrated in FIG. 3, one or more general partitions 322 (only one shown) may comprise processors 102A, 102B, and one or more special partitions 324A, 324X may comprise processors 102C, 102D and 102N, respectively.

As used herein, a “general partition” refers to a portion of a system that is operable to execute a main operating system to manage computing resources. The operating system may comprise any one of several commercially available versions of Windows® sold by Microsoft Corp., Solaris® sold by Sun Microsystems or operating systems sold by WindRiver. Alternatively, the operating system may comprise any one of several versions of open source Linux operating systems. However, these are merely examples of operating systems that may be hosted on a computing platform and embodiments of the present invention are not limited in these respects.

As used herein, a “special partition” refers to a partition that may run in parallel with and/or independently of the general partition. A special partition may, for example, execute a service operating system, which operates independently of the primary operating system (executing on general partition), and can provide tamper-resistant recovery agents to rebuild the primary operating system if a problem occurs. Special partition 324A, . . . , 324X may comprise an embedded partition that is capable of operating independently of the operating system being executed on the general partition 322. In this regard, special partition 324A, . . . , 324X may operate in an out-of-band fashion using, for example, an out-of-band network interface, and general partition 322 may operate in an in-band fashion using, for example, an in-band network interface.

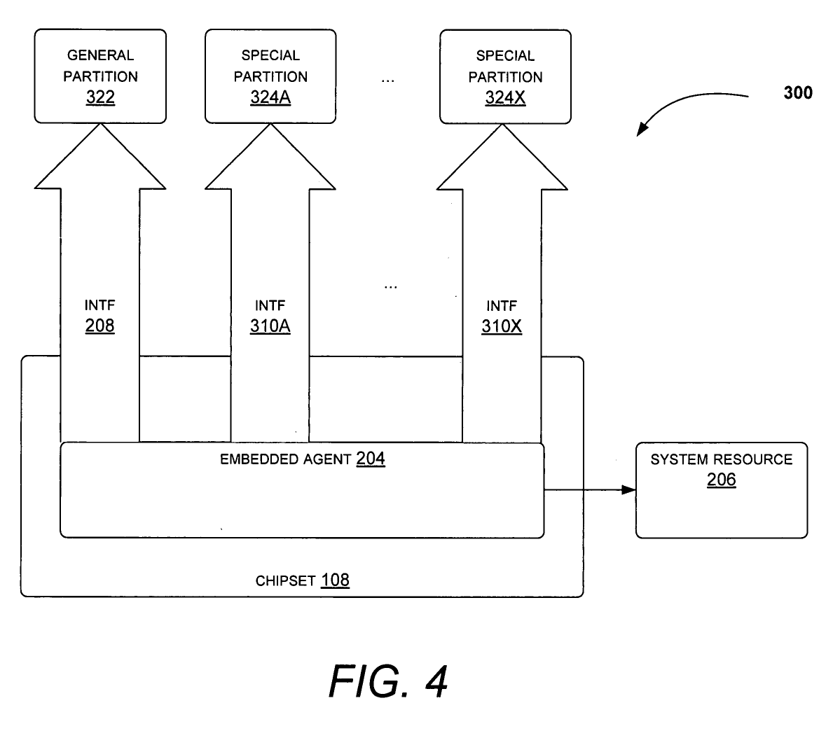

When a platform migrates from an unpartitioned platform, such as platform 100, to a partitioned platform, such as platform 300, it may be desirable for all partitions in platform 300 to utilize certain system resources, such as system resource 206. As an example, system resource 206 may comprise NVS 206 that maintains, for example, a basic input/output system (BIOS), and other code for initiating/initializing various processes. In an unpartitioned platform 100, processors 102A, 102B, 102C, 102C, . . . , 102N may access NVS 206 to, for example, boot the platform 100, and utilize its storage capabilities. In a partitioned platform 300, rather than duplicate NVS 206 or add pins to enable special partitions 324A, . . . , 324X access to NVS 206, one or more additional interfaces can be created. As illustrated in FIG. 4, these one or more additional interfaces may include INTFs 310A, . . . , 310X, each INTF 310A, . . . , 310X corresponding to a respective special partition 324A, . . . , 324X. Furthermore, since embedded agent 204 can allocate portions of NVS 206 to specific applications (as described above), NVS 206 may be further allocated according to the partition, e.g., a specific portion of NVS 206 allocated to general partition 322, and a specific portion(s) allocated to special partition(s) 324A, . . . , 324X.

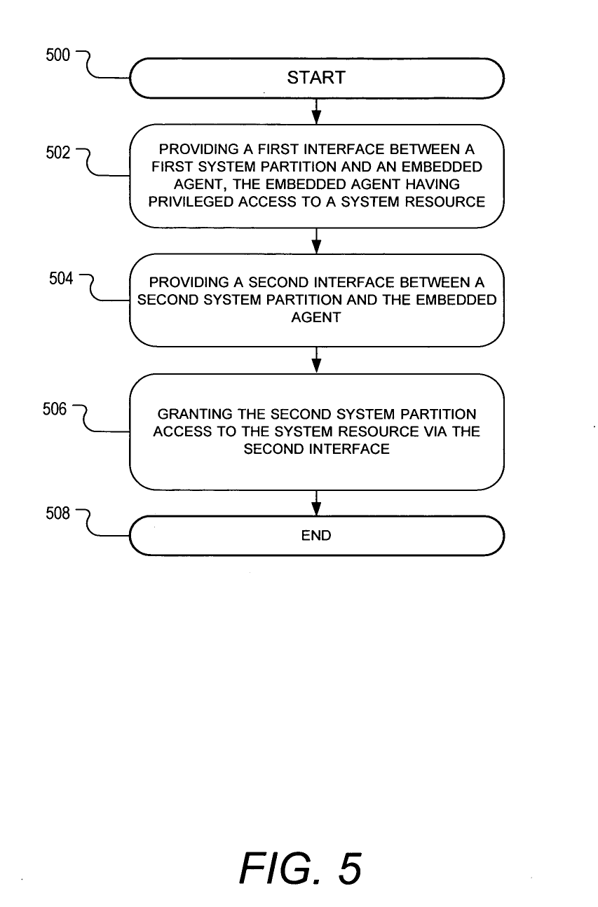

FIG. 5 illustrates a method according to one embodiment of the invention. The method of FIG. 5 begins at block 500 and continues to block 502 where the method may comprise providing a first interface between a first system partition and an embedded agent, the embedded agent having privileged access to a system resource. Embedded agent may comprise embedded agent 204, and first system partition may comprise general partition 322. A first interface between general partition 322 and embedded agent 204 may comprise INTF 208. Furthermore, the first system partition may comprise a set of processors, such as 102A and 102B.

At block 504, the method may comprise providing a second interface between a second system partition and the embedded agent. Second interface may comprise, for example, any one or INTF 310A, . . . , 310X between any one of special partitions 324A, . . . , 324X and embedded agent 204. Furthermore, the second system partition may comprise a set of processors, such as 102A and 102B. In an embodiment, at least one additional interface may be provided, where each additional interface provides an interface between a respective one of at least one other system partition (such as general partition 322, and/or special partitions 324A, . . . , 324X) and the embedded agent (such as embedded agent 204).

How the interfaces INTF 310A, . . . , 310X are provided may be dependent on the type of bus that is used for a given implementation. For example, bus 106 may comply with the Periphera! Component Interconnect (PCI) Local Bus Specification, Revision 2.2, Dec. 18, 1998 (hereinafter referred to as a “PCI bus”) available from the PCI Special Interest Group, Portland, Oreg., U.S.A., or variants thereof, such as PCI Express Base Specification, Revision 1.0a, Apr. 15, 2003 (hereinafter referred to as a “PCI Express bus”) also available from the PCI Special Interest Group. Using one of these standards, for example, a specific instance of a PCI device having its own configuration space may be allocated for each INTF 310A, . . . , 310X. Alternatively, a single instance of a PCI device may be allocated, where each INTF 310A, . . . , 310X may be exposed as a separate range in the base address registers (BARs) of the single PCI device. A configuration space for each INTF 310A, . . . , 310X may include buffers for storing messages to be exchanged between embedded agent 204 and partition 322, 324A, . . . , 324X, as well as control/status registers (CSRs) for managing the buffers.

Partitions 322, 324A, . . . , 324X may be distinguished from one another. Where each INTF 310A, . . . , 310X comprises a PCI device, for example, the unique hardware instance of the INTF 310A, . . . , 310X comprising the PCI bus, device, and function number assigned to the device may be used. Alternatively, where each INTF 310A, . . . , 310X is exposed as separate ranges in the BAR of a single PCI device, each INTF 310A, . . . , 310X may be distinguished by using in-processor resources to map one INTF 310A, . . . , 310X to a given partition 322A, 324A, . . . , 324X. For other standards, such as the SCI (Scalable Coherent Interface) interconnect, IEEE standard 1596-1992, IEEE Standard for the Scalable Coherent Interface, available from IEEE, 345 East 47^{th} Street, New York, N.Y., 10017-2934, USA, a partition I.D. may be used to distinguish between partitions 322, 324A, . . . , 324X.

In an embodiment, first and second partitions may be launched in a serial manner. For example, a BIOS may be run, which may launch a virtual machine monitor (VMM) to enable multiple operating systems and/or application stacks to be loaded on top of the VMM. Subsequently, a service operating system may be launched in an embedded partition, and a primary operating system may be launched in the general partition.

At block 506, the method may comprise granting the second system partition access to the system resource via the second interface. This access may be performed independently of and concurrently with INTF 208. For example, since each INTF 310A, . . . , 310X has its own set of resources (e.g., registers and buffers) to enable communications between embedded agent 204 and a given interface (e.g., general partition 322 or any one of special partitions 324A, . . . , 324X), the resources on one interface may work independently of resources on another interface, enabling the system resource 206 to be accessed independently.

For example, the second system partition 324A, . . . , 324X may access the system resource (e.g., NVS 206) through the second interface (e.g., INTF 310A, . . . , 310X). In an embodiment, accessing the system resource 206 may be done using messages. For example, to write data to NVS 206, one of processors, for example processor 102A, may check a bit in the CSR of embedded processor 204 to determine if embedded processor 204 is ready to accept messages. Processor 102A may also read its own CSR to determine if there is enough space available in its buffer to write a message. If both conditions are met, processor 102A may set its generate interrupt bit in its CSR that may trigger an interrupt message to embedded agent 204, resulting in embedded agent's 204 CSR to be set. Subsequently, embedded agent 204 may read processor's 102A CSR to determine the length of the message in processor's 102A buffer. Embedded agent 204 may then write data to NVS 206 in accordance with the message.

The method may end at block 508.

### Conclusion

Therefore, in an embodiment, a method may comprise providing a first interface between a first system partition and an embedded agent, the embedded agent having privileged access to a system resource; providing a second interface between a second system partition and the embedded agent; and granting the second system partition access to the system resource via the second interface.

Embodiments of the invention may enable one or more partitions in a partitioned platform to access a system resource without the need to duplicate the system resource. For example, this may be useful in systems where a particular system resource may

In the foregoing specification, the invention has been described with reference to specific embodiments thereof. It will, however, be evident that various modifications and changes may be made to these embodiments without departing therefrom. The specification and drawings are, accordingly, to be regarded in an illustrative rather than a restrictive sense.

What is claimed is:

1. A method comprising:
providing a first interface between a first system partition and an embedded agent, the embedded agent having privileged access to a system resource;
providing a second interface between a second system partition and the embedded agent; and
granting the second system partition access to the system resource via the second interface.

2. The method of claim 1, wherein the first system partition comprises a first set of processors of a plurality of processors, and the second system partition including a second set of processors of the plurality of processors.

3. The method of claim 1, additionally comprising providing at least one additional interface, each of the additional interfaces to provide an interface between a respective one of at least one other system partition and the embedded agent.

4. The method of claim 3, wherein each of the at least one additional system partitions includes an additional set of processors of the plurality of processors.

5. The method of claim 1, wherein the system resource comprises flash memory.

6. The method of claim 1, wherein the first system partition comprises a general partition that executes a primary operating system.

7. The method of claim 6, wherein the second system partition comprises a special partition that executes a special operating system independently of the primary operating system.

8. The method of claim 1, wherein the embedded agent enables manageability functions in an out-of-band manner.

9. An apparatus comprising:
an embedded agent having privileged access to a system resource, the embedded agent having:
a first interface to communicate with a first system partition; and
a second interface to communicate with a second system partition.

10. The apparatus of claim 9, wherein the first system partition comprises a first set of processors of a plurality of processors, and the second system partition including a second set of processors of the plurality of processors.

11. The apparatus of claim 9, additionally comprising providing at least one additional interface, each of the additional interfaces to provide an interface between a respective one of at least one other system partition and the embedded agent.

12. The apparatus of claim 11, wherein each of the at least one additional system partitions includes an additional set of processors of the plurality of processors.

13. The apparatus of claim 9, wherein the system resource comprises flash memory.

14. The apparatus of claim 9, wherein the first system partition comprises a general partition that executes a primary operating system.

15. The apparatus of claim 14, wherein the second system partition comprises a special partition that executes a special operating system independently of the primary operating system.

16. The apparatus of claim 9, wherein the embedded agent enables manageability functions in an out-of-band manner.

17. A system comprising:
a network controller; and
an embedded agent located on the network controller, having privileged access to a system resource, the embedded agent having:
a first interface to communicate with a first system partition; and
a second interface to communicate with a second system partition.

18. The system of claim 17, wherein the first system partition comprises a general partition that executes a primary operating system.

19. The system of claim 18, wherein the second system partition comprises a special partition that executes a special operating system independently of the primary operating system.

20. The system of claim 17, wherein the embedded agent enables manageability functions in an out-of-band manner.

21. An article of manufacture having stored thereon instructions, the instructions when executed by a machine, result in the following:
providing a first interface between a first system partition and an embedded agent, the embedded agent having privileged access to a system resource;
providing a second interface between a second system partition and the embedded agent; and
granting the second system partition access to the system resource via the second interface.

22. The article of claim 21, wherein the first system partition comprises a first set of processors of a plurality of processors, and the second system partition including a second set of processors of the plurality of processors.

23. The article of claim 21, wherein said instructions that result in providing a first interface and a second interface additionally comprises instructions that result in providing at least one additional interface, each of the additional interfaces to provide an interface between a respective one of at least one other system partition and the embedded agent.

24. The article of claim 23, wherein each of the at least one additional system partitions includes an additional set of processors of the plurality of processors.

25. The article of claim 21, wherein the system resource comprises flash memory.
